(19) United States
(12) Patent Application Publication
(10) Pub. No.: US 2013/0110591 A1
(43) Pub. Date: May 2, 2013

(54) METHODS AND SYSTEMS FOR PROVIDING SOCIAL CONSUMER DRIVEN GEO INCENTIVES

(71) Applicants: John Vijoe George, Champaign, IL (US); Jonathan Kilroy, Champaign, IL (US); Allie K. Watfa, Urbana, IL (US); Dale Nussel, Mahomet, IL (US)

(72) Inventors: John Vijoe George, Champaign, IL (US); Jonathan Kilroy, Champaign, IL (US); Allie K. Watfa, Urbana, IL (US); Dale Nussel, Mahomet, IL (US)

(73) Assignee: Yahoo! Inc., Sunnyvale, CA (US)

(21) Appl. No.: 13/285,053

(22) Filed: Oct. 31, 2011

(51) Int. Cl. G06Q 30/02

(52) U.S. Cl. 705/14.1

(57) ABSTRACT

Techniques which allow potential customers that may be travelling near a vendor to propose a discounted group purchase offer to the vendor. A group of one or more potential customers travelling in a predetermined direction within a predetermined distance from a vendor's geographic location may be detected substantially in real time. The group may then be connected into a virtual social network and allowed to communicate with one another to collaborate on a discounted group purchase offer. The group may propose the discounted group purchase offer to the vendor.

### BACKGROUND

Advertisers (including proxies, agents, or other entities acting on behalf of or in the interest of advertisers) compete for user attention. One particular target audience of interest to advertisers is users who are travelling, whether on foot or in vehicles. Currently location based advertising is based on showing users all vendors that are located near or around the user's location.

There is a need for techniques to allow a group of individuals (known or unknown to one another) to offer group purchase proposals to vendors.

### SUMMARY

Exemplary embodiments of the invention provide methods and systems for allowing potential customers that are traveling to propose discounted group purchase offers to nearby vendors. A group of one or more potential customers travelling in a predetermined direction within a predetermined distance from a vendor's geographic location may be detected substantially in real time. The potential customers may be travelling in their respective vehicles or may be travelling by foot (e.g., walking in a shopping mall). For example, the system may detect how many potential customers are travelling towards a vendor within a 5 mile radius. In accordance with an exemplary embodiment, the potential customers may be detected by for example tracking users' mobile devices. The mobile devices may include smart phones, PDAs, tablets, laptops, GPS navigation units, etc. In addition, the mobile devices may also include in-vehicle GPS navigation systems. The devices may be tracked using GPS enabled radios which are common in modern mobile devices. Alternatively, or in addition, the mobile devices may also be tracked using triangulation techniques that would be apparent to one of ordinary skill in the art.

The group of one or more potential customers may be connected into a virtual social network. In one embodiment, they may be connected into an existing social network. In some embodiments, a virtual social network may be created.

The group of one or more potential customers may be allowed to communicate with each other over the virtual social network to collaborate on a discounted group purchase offer. In one embodiment, once connected in the virtual social network, the potential customers may be allowed to send and receive messages to/from each other.

The group may be allowed to propose the discounted group purchase offer to the vendor. This advantageously allows the group of individuals (known or unknown to one another) to speak with one voice to the vendor and make a discounted group purchase offer.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a flow diagram illustrating a method according to one embodiment of the invention; and

FIG. 5 is a block diagram illustrating one embodiment of the invention.

While the invention is described with reference to the above drawings, the drawings are intended to be illustrative, and the invention contemplates other embodiments within the spirit of the invention.

### DETAILED DESCRIPTION

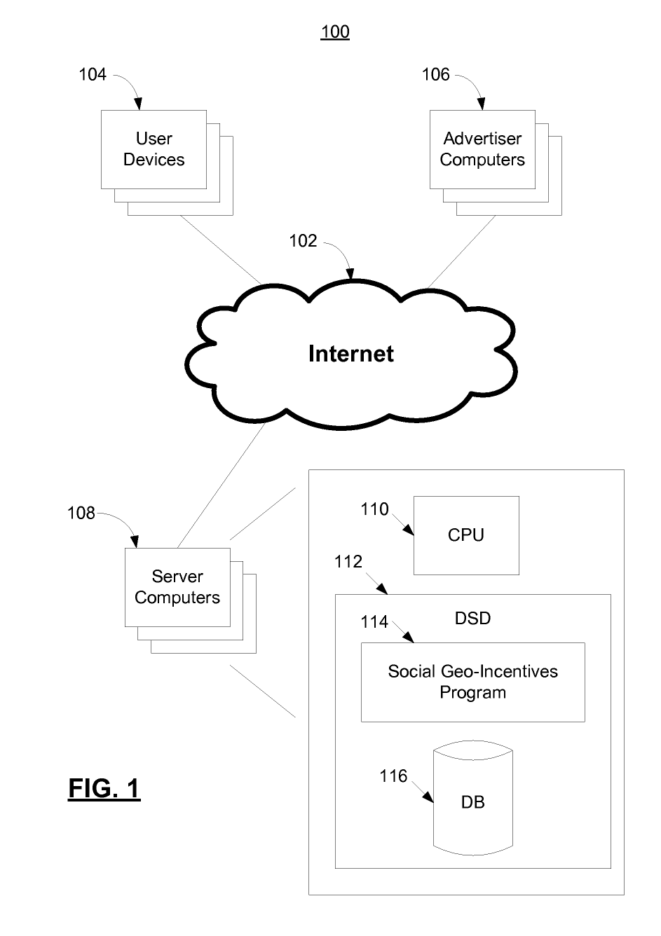

FIG. 1 is a distributed computer system 100 according to one embodiment of the invention. The system 100 includes user devices 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user devices 104 may be portable or handheld devices such as smart phones, PDAs, tablets, laptops, GPS navigation units, etc.

Each of the one or more computers 106 and 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, graphical advertisements, rich advertisements, video advertisements, etc.

As depicted, each of the server computers 108 includes one or more CPUs 110 and a data storage device 112. The data storage device 112 includes a database 116 and a Social Geo Incentives Program 114.

The Program 114 is intended to broadly include all programming, applications, algorithms, software and other and tools necessary to implement or facilitate methods and systems according to embodiments of the invention. The elements of the Program 114 may exist on a single server computer or be distributed among multiple computers or devices.

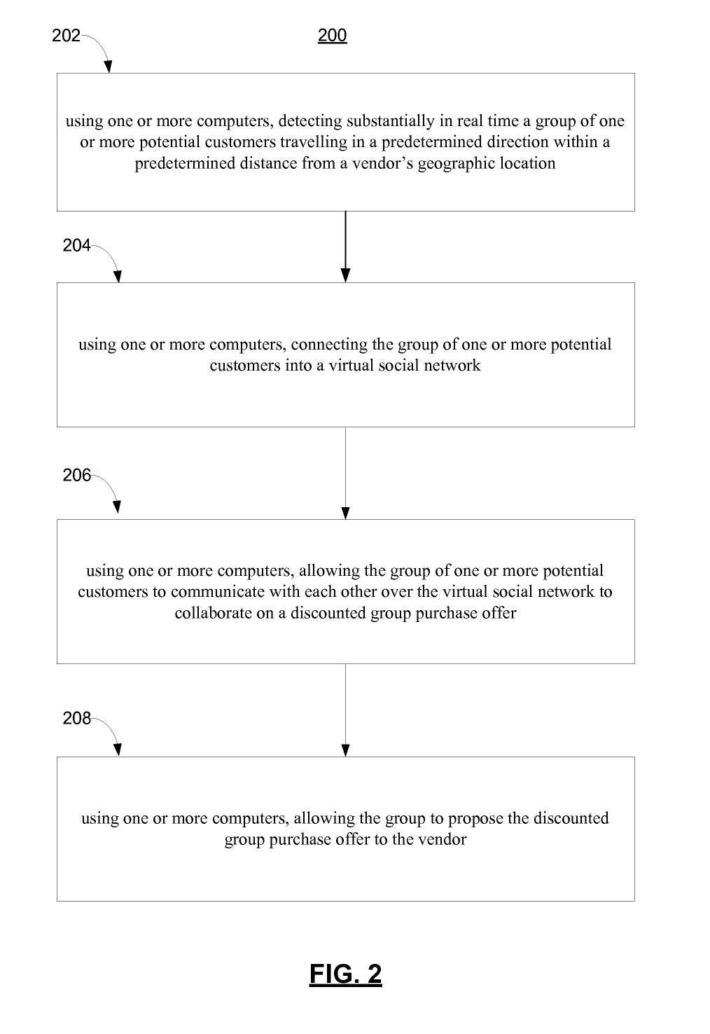

FIG. 2 is a flow diagram illustrating a method 200 according to one embodiment of the invention. At step 202, using one or more computers, a group of one or more potential customers travelling in a predetermined direction within a predetermined distance from a vendor's geographic location may be detected substantially in real time. The potential customers may be travelling in their respective vehicles or may be travelling by foot (e.g., walking in a shopping mall). For example, the system may detect how many potential customers are travelling towards a vendor within a 5 mile radius. In accordance with an exemplary embodiment, the potential customers may be detected by for example tracking users' mobile devices. The mobile devices may include smart phones, PDAs, tablets, laptops, GPS navigation units, etc. In addition, the mobile devices may also include in-vehicle GPS navigation systems. The devices may be tracked using GPS enabled radios which are common in modern mobile devices. Alternatively, or in addition, the mobile devices may also be tracked using triangulation techniques that would be apparent to one of ordinary skill in the art.

At step 204, using one or more computers, the group of one or more potential customers may be connected into a virtual social network.

At step 206, using one or more computers, the group of one or more potential customers may be allowed to communicate with each other over the virtual social network to collaborate on a discounted group purchase offer. In one embodiment, once connected in the virtual social network, the potential customers may be allowed to send and receive messages to/from each other.

At step 208, using one or more computers, the group may be allowed to propose the discounted group purchase offer to the vendor. This advantageously allows the group of individuals (known or unknown to one another) to speak with one voice to the vendor and make a discounted group purchase offer.

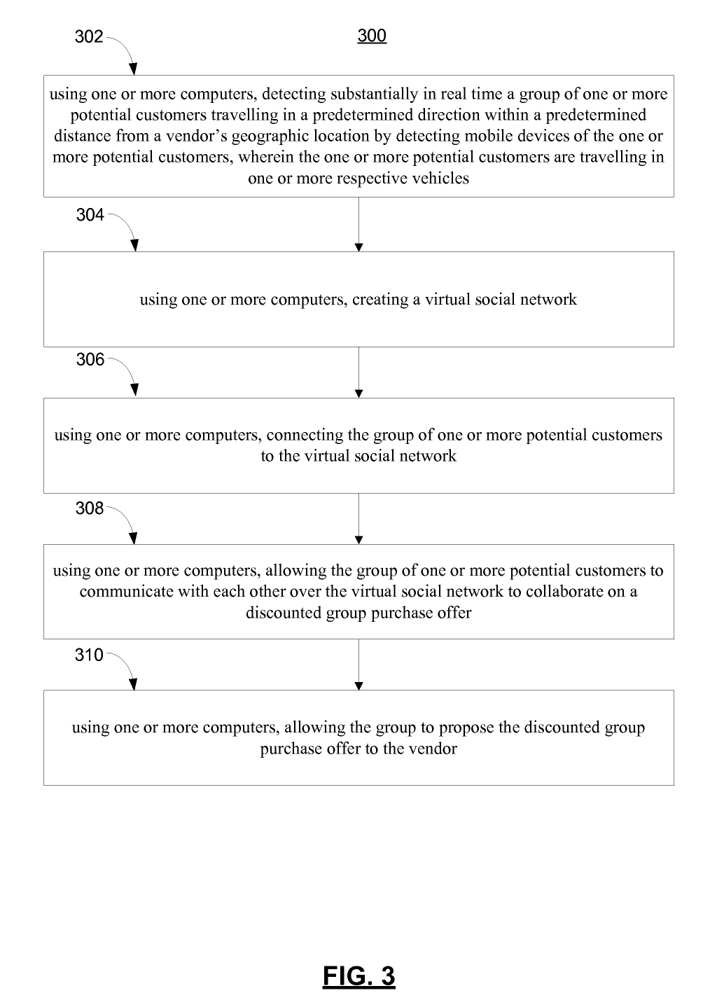

FIG. 3 is a flow diagram illustrating a method 300 according to one embodiment of the invention. At step 302, using one or more computers, a group of one or more potential customers travelling in a predetermined direction within a predetermined distance from a vendor's geographic location may be detected substantially in real time by detecting mobile devices of the one or more potential customers, wherein the one or more potential customers are travelling in one or more respective vehicles. For example, a vendor may wish to detect how many potential customers are travelling towards the vendor within a 5 mile radius. In accordance with an exemplary embodiment, the potential customers may be detected by for example tracking users' mobile devices. The mobile devices may include smart phones, PDAs, tablets, laptops, GPS navigation units, etc. In addition, the mobile devices may also include in-vehicle GPS navigation systems. The devices may be tracked using GPS enabled radios which are common in modern mobile devices. Alternatively, or in addition, the mobile devices may also be tracked using triangulation techniques that would be apparent to one of ordinary skill in the art.

At step 304, using one or more computers, a virtual social network may be created. At step 306, using one or more computers, the group of one or more potential customers may be connected to the virtual social network.

At step 308, using one or more computers, the group of one or more potential customers may be allowed to communicate with each other over the virtual social network to collaborate on a discounted group purchase offer.

At step 310, using one or more computers, the group may be allowed to propose the discounted group purchase offer to the vendor. In an exemplary scenario, a family is traveling on the highway around dinner time. The family will get a message or chat notification on their smart phone(s) providing them the option to connect them to other nearby travelers traveling in the same direction, with the intention to establish a deal between a vendor and the travelers. Once the family is connected to the other travelers, they can collaborate and decide on a restaurant and a discounted group purchase offer. The group of travelers can then present the offer to the restaurant. The restaurant may accept of present a counter offer to the travelers. After negotiation, an agreement may be reached that satisfies both the restaurant and the group of travelers.

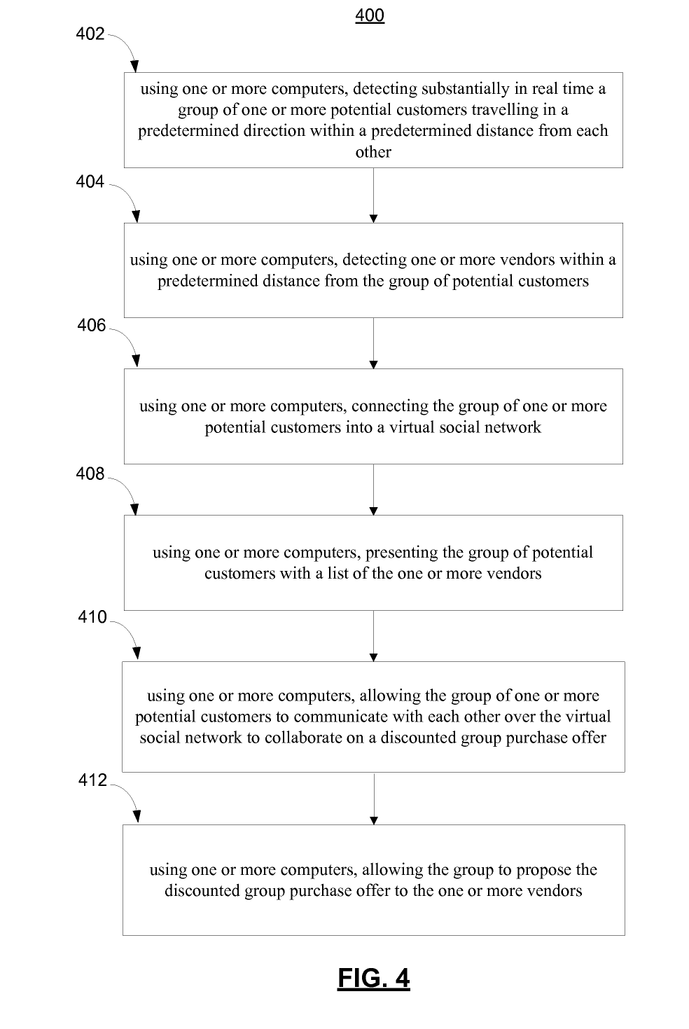

FIG. 4 is a flow diagram illustrating a method 400 according to one embodiment of the invention. At step 402, using one or more computers, a group of one or more potential customers travelling in a predetermined direction within a predetermined distance from each other may be detected substantially in real time. In the exemplary scenario described above, the family traveling on the highway and additional travelers near them may be detected substantially in real time. The potential customers may be travelling in their respective vehicles or may be travelling by foot (e.g., walking in a shopping mall).

At step 404, using one or more computers, one or more vendors within a predetermined distance from the group of potential customers may be detected.

At step 406, using one or more computers, the group of one or more potential customers may be connected into a virtual social network. As described in the exemplary scenario above, the family may get a message or chat notification on their smart phone(s) providing them the option to connect them to other nearby travelers.

At step 408, using one or more computers, the group of potential customers may be presented with a list of the one or more nearby vendors. In some embodiments, vendors may be allowed to bid against each other in order for their business listing to be displayed to nearby travelers. For example, there may be a large number of restaurants near a busy off-ramp, and the restaurants may bid against each other to have their listing displayed to nearby travelers, or to have their listing displayed near the top of the results.

At step 410, using one or more computers, the group of one or more potential customers may be allowed to communicate with each other over the virtual social network to collaborate on a discounted group purchase offer. Once the travelers agree on the vendor(s) and the discounted group purchase offer, the group may be allowed to propose the discounted group purchase offer to the one or more vendors in step 412.

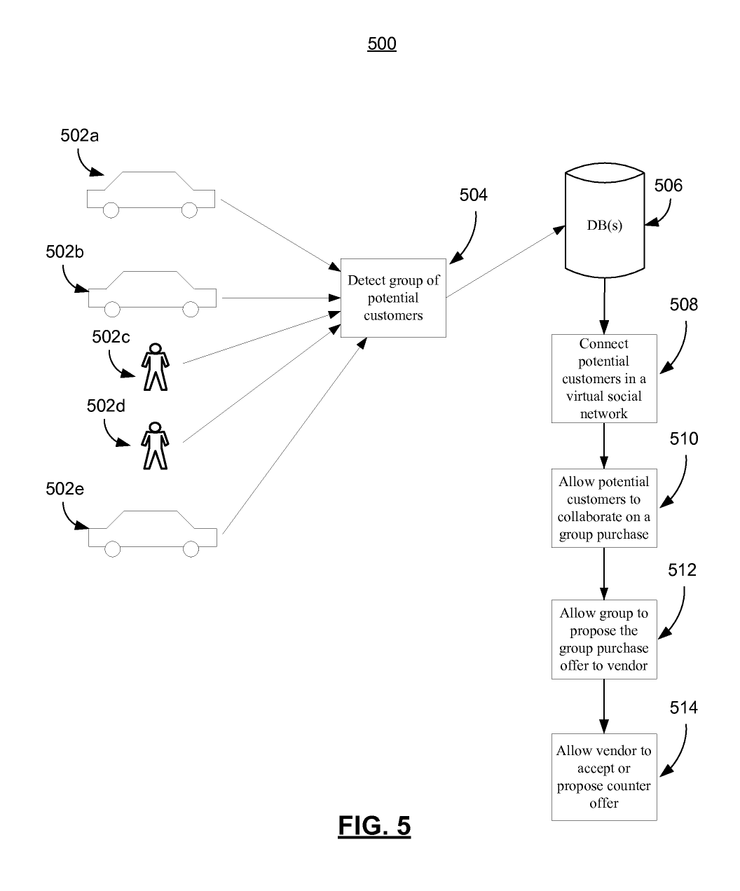

FIG. 5 is a block diagram 500 illustrating one embodiment of the invention. One or more data stores or databases 506 are depicted. Database 506 may be implemented on, for example, one or more server computers 108 (FIG. 1) and/or one or more advertiser computers 106 (FIG. 1). Various types of information are stored in the database 506. In particular, types of information stored in the database 506 include, potentially among many other types of information, device information, vehicle information, location information, etc.

Block 504 represents detection of a group of one or more potential customers 502a-502e. The potential customers may be travelling in one or more vehicles or may be travelling on foot (e.g., walking in a shopping mall or airport). In accordance with an exemplary embodiment, the potential customers may be detected by for example tracking users' mobile devices. The mobile devices may include smart phones, PDAs, tablets, laptops, GPS navigation units, etc. In addition, the mobile devices may also include in-vehicle GPS navigation systems. The devices may be tracked using GPS enabled radios which are common in modern mobile devices. Alternatively, or in addition, the mobile devices may also be tracked using triangulation techniques that would be apparent to one of ordinary skill in the art. The information collected may be stored in database 506, as described above.

As depicted in block 508, the group of one or more potential customers may be connected into a virtual social network. In some embodiments, the social network may be an existing social network. Alternatively, the virtual social network may be created to allow the group of travelers to be connected with each other.

As depicted in block 510, the group of one or more potential customers may be allowed to communicate with each other over the virtual social network to collaborate on a discounted group purchase offer. In some embodiments, the group may be presented with a list of nearby vendors, and may also include additional information on the vendors (e.g., hours of operation, menus, prices, current promotions, etc.). The group may collaborate on which vendor(s) to select, and on the terms of the group purchase offer (e.g., 20% discount for a group of 10 customers). In some embodiments, the list of nearby vendors may also include a history of successful (or unsuccessful) proposals previously made by other travelers. This may aid the travelers in collaborating on a group purchase offer which has a high chance of acceptance by the vendor.

As depicted in block 512, the group may be allowed to propose the discounted group purchase offer to the vendor(s). For example, the group may present the same offer to multiple vendors to increase the chance of acceptance.

As depicted in block 514, the vendor(s) may accept the group's offer, or present a counter offer, which the group may accept or reject.

The exemplary embodiments described above may be used independently, or in combination, by travelers to propose discounted group purchase offers to vendors. In accordance with the exemplary embodiments, some use case scenarios will now be described.

One example is a restaurant located on an Interstate off-ramp. After the noon lunch rush, activity has died down for the restaurant, with few customers still remaining. The restaurant receives an appealing offer from a group of school buses heading their way, the offer is for kids to eat free. The restaurant realizing that the school buses may include a large number of children, presents a counter offer for one free kid for one regular adult. The approaching customers accept.

Another example is a family traveling in a van, which is low on gas. They log-in to the system and connect with other travelers. The group sends an offer to multiple gas stations in the area requesting a 1% discount on current standard rate. No gas station accepts the offer while one gas station produces a counter offer. The family provides their van's license plate number to the gas station for identification and accepts the counter offer.

Another example is a group of people driving to watch a game, however, they have no tickets. The system identifies other travelers traveling towards the stadium, and groups them. The group is allowed to negotiate a discounted rate with the ticket vendor.

While the invention is described with reference to the above drawings, the drawings are intended to be illustrative, and the invention contemplates other embodiments within the spirit of the invention.

1. A method comprising:
using one or more computers, detecting substantially in real time a group of one or more potential customers travelling in a predetermined direction within a predetermined distance from a vendor's geographic location;
using one or more computers, connecting the group of one or more potential customers into a virtual social network;
using one or more computers, allowing the group of one or more potential customers to communicate with each other over the virtual social network to collaborate on a discounted group purchase offer; and
using one or more computers, allowing the group to propose the discounted group purchase offer to the vendor.

2. The method of claim 1, further comprising:
using one or more computers, allowing the vendor to propose a counter offer to the group in response to receiving the discounted group purchase offer.

3. The method of claim 1, wherein detecting the group of one or more potential customers comprises detecting the location of the one or more potential customers' mobile devices.

4. The method of claim 1, further comprising:
using one or more computers, creating the virtual social network.

5. The method of claim 1, further comprising:
using one or more computers, allowing the vendor to target the group of one or more potential customers with one or more advertisements.

6. The method of claim 5, further comprising:
using one or more computers, transmitting the one or more advertisements to one or more mobile devices of each of the one or more potential customers.

7. The method of claim 1, further comprising:
using one or more computers, allowing the vendor to bid against other vendors for the opportunity to target the group of one or more potential customers with one or more advertisements.

8. The method of claim 1, wherein the one or more potential customers are travelling in one or more respective vehicles.

9. The method of claim 1, wherein the one or more potential customers are travelling by foot.

10. A system comprising:
one or more server computers coupled to a network; and
one or more databases coupled to the one or more server computers;
wherein the one or more server computers are for:
detecting substantially in real time a group of one or more potential customers travelling in a predetermined direction within a predetermined distance from a vendor's geographic location;
connecting the group of one or more potential customers into a virtual social network;
allowing the group of one or more potential customers to communicate with each other over the virtual social network to collaborate on a discounted group purchase offer; and
allowing the group to propose the discounted group purchase offer to the vendor.

11. The system of claim 10, wherein the one or more server computers are further configured for:
allowing the vendor to propose a counter offer to the group in response to receiving the discounted group purchase offer.

12. The system of claim 1, wherein detecting the group of one or more potential customers comprises detecting the location of the one or more potential customers' mobile devices.

13. The system of claim 10, wherein the one or more server computers are further configured for:
creating the virtual social network.

14. The system of claim 10, wherein the one or more server computers are further configured for:
allowing the vendor to target the group of one or more potential customers with one or more advertisements.

15. The system of claim 14, wherein the one or more server computers are further configured for:
transmitting the one or more advertisements to one or more mobile devices of each of the one or more potential customers.

16. The system of claim 10, wherein the one or more server computers are further configured for:
allowing the vendor to bid against other vendors for the opportunity to target the group of one or more potential customers with one or more advertisements.

17. The system of claim 10, wherein the one or more potential customers are travelling in one or more respective vehicles.

18. The system of claim 10, wherein the one or more potential customers are travelling by foot.

19. The system of claim 10, wherein the one or more server computers are further configured for:
allowing the group of one or more potential customers to propose the discounted purchase offer to one or more additional vendors.

20. A computer readable medium or media containing instructions for executing a method comprising:
using one or more computers, detecting substantially in real time a group of one or more potential customers travelling in a predetermined direction within a predetermined distance from a vendor's geographic location by detecting mobile devices of the one or more potential customers, wherein the one or more potential customers are travelling in one or more respective vehicles;
using one or more computers, creating a virtual social network;
using one or more computers, connecting the group of one or more potential customers to the virtual social network;
using one or more computers, allowing the group of one or more potential customers to communicate with each other over the virtual social network to collaborate on a discounted group purchase offer; and
using one or more computers, allowing the group to propose the discounted group purchase offer to the vendor.
